(19) United States
(12) Patent Application Publication
(10) Pub. No.: US 2022/0095648 A1
(43) Pub. Date: Mar. 31, 2022

(54) USE OF A THRAUSTOCHYTRID BIOMASS FOR MAINTAINING GUT BARRIER FUNCTION

(71) Applicant: ADISSEO FRANCE S.A.S., Antony (FR)

(72) Inventors: Cécile GADY, Montluçon (FR); Sabrina VANDEPLAS, Terjat (FR)

(73) Assignee: ADISSEO FRANCE S.A.S., Antony (FR)

(21) Appl. No.: 17/426,927

(22) PCT Filed: Jan. 31, 2020
(86) PCT No.: PCT/EP2020/052474

§ 371 Date: Jul. 29, 2021

(30) Foreign Application Priority Data
Feb. 1, 2019 (EP) PCT/EP2019/052527

(51) Int. Cl. A23K 10/18

(52) U.S. Cl. CPC A23K 10/18; A23K 50/75

(57) ABSTRACT

A method for maintaining gut barrier function in an individual, comprising administering a Thraustochytrid biomass to an animal in need thereof.

### FIELD OF THE INVENTION

The present invention is in the field of nutrition, and more particularly human and animal nutrition. It relates to the use of a Thraustochytrid biomass for maintaining gut barrier function in an individual.

### BACKGROUND OF THE INVENTION

In animal production, several factors during the rearing period are likely to influence the preservation of the animal well-being and the productivity. A wide range of abiotic stressors has been identified, such as social interactions or rough handling, common farm practices (e.g. castration, dehorning, teeth clipping, shoeing, weaning crowding etc), improper feeding, exposure to adverse climatic conditions, exercise, work and transport. Any imbalance in these factors will first induce animal adaptation and tolerance, which may result in behavioral, biological, and physical responses. In case non-adapted conditions are not rapidly corrected, the tolerance threshold may be exceeded and the animal will externalize the imbalance via stress. Stress is a reflex reaction revealed by the inability of an animal to cope with its environment, which may lead to many unfavorable consequences, ranging from discomfort to death. Stress-triggering stimuli are not necessarily painful but may activate physiological responses and the animal could develop behavioral, autonomic, endocrine or immune response to maintain homeostasis. In case the animal is unable to withstand stress, the consequences will be abnormal biological functions, which could lead to the development of psychosomatic disease, immunosuppression, reduced efficiency of production and reproduction. Stress affects ability to perform and may make animals more susceptible to physio-pathological disorders. All these detrimental animal responses are especially in relation, at least partly, to impaired gut physiological function.

The barrier formed by the intestinal epithelium separates the external environment (i.e. the contents of the intestinal lumen) from the body. The intestinal epithelium is composed of a single layer of epithelial cells and serves two crucial functions, which may seem conflicting. On one hand, it must act as a barrier to prevent the entry of microorganisms that inhabit the gastrointestinal tract, as well as undesirable components that may be present in the intestinal chyme. On the other hand, it must facilitate the uptake of dietary nutrients, electrolytes, water and various other beneficial substances from the intestinal lumen.

The gut epithelium maintains its selective barrier function through the formation of complex protein-protein networks that mechanically link adjacent cells and seal the intercellular space, especially through the involvement of tight junctions. Each stress response of the animal will challenge the integrity of the mucosal barrier and the intestinal epithelium will need to adapt to a multitude of signals in order to perform the complex process of maintenance and restitution of its barrier function. A well-functioning epithelium is also crucial to optimize the absorption of dietary nutrients that are essential for efficient metabolic processes. Conditions able to help the animal to maintain its gut barrier integrity are then the touchstone for steady physiological status required to face adverse rearing conditions.

To overcome the impact of stressful conditions on gut physiological function and animal productivity, many different strategies have been proposed. The current solutions are generally prophylactic with the use of dietary antibiotic-growth promoters (AGP) and biosecurity measures to control environmental parameters. With the concerns regarding antibiotic resistance and the difficulties related to the identification of proper management practices/biosecurity measures, and their interactions, alternative prophylactic methods have been developed in order to provide complementary solutions to an integrative approach at the farm level. Combination of feed additives to support host digestive processes and gut physiological function are especially the focus of many research teams around the world. These include probiotics, prebiotics, short- and medium-chain fatty acids, herbal compounds, among other molecules (Van Immerseel et al. (2017), Microb. Biotechnol., 10(5): 1008-1011). As a key issue in production animals is digestibility of nutrients and energy harvest from the diet, supplementation with digestive enhancers (such as enzymes) is also used to manage dietary stresses. However, in addition to complicating diet formulation and associated costs, the interactions induced by supplementing different feed additives are not always fully described and well-known.

Therefore, it would be desirable to develop functional ingredients allowing both to bring essential nutrients such as protein and amino acids, and to offer protection against multifactorial stress, while maintaining gut barrier integrity and preventing the transfer of undesirable compounds into the body, in order to reduce diet and veterinary costs, while securing rearing practices.

Thraustochytrid microalgae are known for their use in biofuel production and as a source of polyunsaturated fatty acids. It has also been shown, in WO2017/012931, that protein-rich biomass of Thraustochytrids can improve animal performance in animals receiving a standard starter diet based on corn and soybean meal (which is optimal for chicken metabolism), and which are not submitted to stressful conditions (such as nutritional/dietary stressor(s)). WO2004/080196 discloses animal feed comprising lower fungal biomass (e.g. from Thraustochytrid microalgae), which can have a wide range of effects, including the improvement of gut function, stimulation of probiont colonization, and improved food conversion. Similarly here, the animals are not submitted to stressful conditions (whether in terms of environmental conditions e.g. stocking density, or diet).

The invention disclosed in US 2017/0369681 consists in a combination of microalgae (including Thraustochytrid microalgae) and soluble indigestible fibers, having a synergistic effect on the stimulation of bacteria of the intestinal flora, their enzymes production, as well as the protection of intestinal health through the release of active agents from the lysed microalgae (whereas such effects are not observed with the microalgae alone). Moreover, it was disclosed in this document that microalgae (and more particularly, Chlorella vulgaris, Chlorella saccharophila, Scenedesmus, Chlamydomonas reinhardtii or Dunaliella salina), can adsorb toxins synthesized by enteropathogenic bacteria, on their cell wall (some of these toxins being implicated in numerous intestinal diseases, including inflammatory diseases). However, it is known that cell wall composition can vary significantly between different microalgae, and in particular, the cell wall composition of Thraustochytrids is very different from the cell wall composition of Chlorella (Domozych et al (2012), Frontiers in Plant Science, 3:82; Gerken et al (2013), Planta, 237(1):239-253; Darley et al (1973), Arch. Mikrobiol., 90:89-106). In Bedirli et al (2009), Clinical Nutrition 28: 674-678, it was also shown that different microalgae can have different effects; in particular, Chlorella microalgae, but not Spirulina microalgae, could reduce intestinal translocation of bacteria and endotoxin in obstructive jaundice.

It has now been discovered by the inventors, completely unexpectedly, that Thraustochytrid microalgae allow both to bring essential nutrients such as protein and amino acids, and to offer protection against multifactorial stress, while maintaining gut barrier integrity and preventing the transfer of undesirable compounds into the body.

### DESCRIPTION OF THE INVENTION

Therefore, the present invention relates to the use of a Thraustochytrid biomass for maintaining gut barrier function in an individual.

In the context of the present invention:
The term “Thraustochytrid” refers to microalgae or unicellular protists of the Thraustochytriaceae family. This family belongs to the Thraustochytriales order and to the Labyrinthulomycetes class;
The term “biomass” refers to a set of cells, which have been produced by culturing said cells (in general, in a fermenter), and wherein said cells may retain their physical integrity, or not. A biomass may comprise a quantity of degraded cells, ranging from 0% to 100%. The term “degraded” means that said cells may have had their structure modified. For instance, they may have undergone a lysis step, a step of transformation by fermentation and/or a drying step;
The term “maintaining gut barrier function” is to be understood as meaning that the barrier function of the gut is maintained in a functional or physiological state. The barrier function of the gut is to serve as a selective filter for some nutrients to pass through the gut, and be effectively digested and absorbed, while preventing some other undesirable components to pass through the gut. More particularly, when an individual is submitted to a stressor (as can for instance occur in adverse rearing conditions) or a challenge (i.e. a factor which destabilizes gut barrier function, such as a factor which affects gut permeability), the Thraustochytrid biomass according to the invention allows to avoid or limit the effects on gut barrier function associated with such a stressor or challenge. Preferably, in such conditions of stress or challenge, when the Thraustochytrid biomass according to the invention is used, gut barrier function is not statistically different from gut barrier function in the absence of stressor or challenge. Gut barrier function can for instance be assessed by measuring gut permeability, or by measuring nutrient uptake (as described in Example 2). Gut permeability can be measured using methods well-known to a skilled person, such as Transepithelial Electrical Resistance (TER) measurements, or evaluation of the permeation of FITC-dextran through the gut compartment. In particular, TER allows to give an indication of the enterocyte monolayer membrane integrity, by applying an AC electrical signal across electrodes placed on both sides of a cellular monolayer and measuring voltage and current to calculate the electrical resistance of the barrier. The higher the TER value is, the tighter the gut barrier is, and the lower the permeability is;
The term “individual” refers to a human or an animal;
The term “livestock animals” refers to domesticated animals raised in an agricultural setting to produce labor and various commodities; more particularly, grazing animals (particularly cattle raised for meat, milk, cheese and leather; sheep raised for meat, wool and cheese; caprines), pigs, rabbits, poultry (chickens, hens, turkeys, ducks, geese, etc.), members of the horse family (ponies, horses, foals), animals intended to support human activities or the feeding thereof, aquatic animals (for example fish, shrimp, oysters and mussels).
“Pets” or “leisure animals” refer to animals, which are kept at home as companions. They include mammals, and in particular dogs and cats, but also aquarium fish or aviary or caged birds.

Preferably, the Thraustochytrid biomass is used for maintaining gut barrier function in an individual, preferably an animal, who is submitted to stressful or challenging conditions, in particular stressor(s) or challenge(s) which can impair gut physiological function. In animal production, a wide range of abiotic stressors has been identified, which can in particular be related to:
social interactions (e.g. feather picking, tail biting, etc),
common farm practices (e.g. rough handling, castration, dehorning, teeth clipping, shoeing, weaning, crowding, high stocking density, transport, heating, ventilation, air conditioning, etc),
nutritional conditions (e.g. competition for feeding, alternative less digestible ingredients, etc), and
environmental conditions (e.g. wet litter, excessive ammonia production, exposure to adverse climatic conditions, etc).

Stressors can in particular occur in intensive animal breeding/livestock operations and adverse rearing conditions.

Preferably, the Thraustochytrid used according to the present invention is selected from the group consisting of:
a Thraustochytrid of a genus Aplanochytrium; more preferably of a species Aplanochytrium sp., Aplanochytrium kerguelense, Aplanochytrium minuta, Aplanochytrium stocchinoi; even more preferably of a strain Aplanochytrium sp. PR24-1;
a Thraustochytrid of a genus Aurantiochytrium; more preferably of a species Aurantiochytrium sp., Aurantiochytrium limacinum, Aurantiochytrium mangrovei; even more preferably of a strain Aurantiochytrium sp. AB052555, Aurantiochytrium sp. AB073308, Aurantiochytrium sp. ATCC PRA276 DQ836628, Aurantiochytrium sp. BL10 FJ821477, Aurantiochytrium sp. LY 2012 PKU Mn5 JX847361, Aurantiochytrium sp. LY2012 JX847370, Aurantiochytrium sp. N1-27, Aurantiochytrium sp. SD116, Aurantiochytrium sp. SEK209 AB290574, Aurantiochytrium sp. SEK217 AB290572, Aurantiochytrium sp. SEK 218 AB290573, Aurantiochytrium sp. 18W-13a, Aurantiochytrium limacinum AB022107, Aurantiochytrium limacinum HM042909, Aurantiochytrium limacinum JN986842, Aurantiochytrium limacinum SL1101, Aurantiochytrium mangrovei DQ323157, Aurantiochytrium mangrovei DQ356659, Aurantiochytrium mangrovei DQ367049, Aurantiochytrium mangrovei CCAP 4062/1, Aurantiochytrium mangrovei CCAP 4062/2, Aurantiochytrium mangrovei CCAP 4062/3, Aurantiochytrium mangrovei CCAP 4062/4, Aurantiochytrium mangrovei CCAP 4062/5, Aurantiochytrium mangrovei CCAP 4062/6;
a Thraustochytrid of a genus Botryochytrium; more preferably of a species Botryochytrium sp., Botryochytrium radiatum; even more preferably of a strain Botryochytrium sp. BUTRBC 143, Botryochytrium sp. Raghukumar 29, Botryochytrium radiatum Raghukumar 16, Botryochytrium radiatum SEK353;
a Thraustochytrid of a genus Japonochytrium;
a Thraustochytrid of a genus Oblongichytrium; more preferably of a species Oblongichytrium sp., Oblongichytrium minutum, Oblongichytrium multirudimentalis; even more preferably of a strain Oblongichytrium sp. SEK347;
a Thraustochytrid of a genus Parieticytrium; more preferably of a species Parieticytrium sp., Parieticytrium sarkarianum; even more preferably of a strain Parieticytrium sp. F3-1, Parieticytrium sp. H1-14, Parieticytrium sp. NBRC102984, Parieticytrium sarkarianum SEK351, Parieticytrium sarkarianum SEK364;
a Thraustochytrid of a genus Phytophthora; more preferably of a species Phytophthora infestans;
a Thraustochytrid of a genus Schizochytrium; more preferably of a species Schizochytrium sp., Schizochytrium aggregatum, Schizochytrium limacinum, Schizochytrium mangrovei; even more preferably of a strain Schizochytrium sp. ATCC20888 DQ367050, Schizochytrium sp. KGS2 KC297137, Schizochytrium sp. SKA10 JQ248009, Schizochytrium sp. ATCC 20111, Schizochytrium sp. ATCC 20888, Schizochytrium sp. ATCC 20111 DQ323158*, Schizochytrium sp. ATCC 20888 DQ356660, Schizochytrium sp. ATCC 20889, Schizochytrium sp. ATCC 26185, Schizochytrium sp. BR2.1.2, Schizochytrium sp. BUCAAA 032, Schizochytrium sp. BUCAAA 093, Schizochytrium sp. BUCACD 152, Schizochytrium sp. BUCARA 021, Schizochytrium sp. BUCHAO 113, Schizochytrium sp. BURABQ 133, Schizochytrium sp. BURARM 801, Schizochytrium sp. BURARM 802, Schizochytrium sp. CCAP 4087/3, Schizochytrium sp. CCAP 4087/1, Schizochytrium sp. CCAP 4087/4, Schizochytrium sp. CCAP 4087/5, Schizochytrium sp. FJU-512, Schizochytrium sp. KH105, Schizochytrium sp. KK17-3, Schizochytrium sp. KR-5, Schizochytrium sp. PJ10.4, Schizochytrium sp. SEK 210, Schizochytrium sp. SEK 345, Schizochytrium sp. SEK 346, Schizochytrium sp. SR21, Schizochytrium sp. T1001, Schizochytrium aggregatum DQ323159, Schizochytrium aggregatum DQ356661, Schizochytrium limacinum OUC166 HM042907, Schizochytrium mangrovei FB1, Schizochytrium mangrovei FB3, Schizochytrium mangrovei FBS;
a Thraustochytrid of a genus Sicyoidochytrium; more preferably of a species Sicyoidochytrium minutum; even more preferably of a strain Sicyoidochytrium minutum SEK354, Sicyoidochytrium minutum NBRC 102975, Sicyoidochytrium minutum NBRC 102979;
a Thraustochytrid of a genus Thraustochytriidae; more preferably of a species Thraustochytriidae sp.; even more preferably of a strain Thraustochytriidae sp. BURABG162 DQ100295, Thraustochytriidae sp. CG9, Thraustochytriidae sp. LY2012 JX847378, Thraustochytriidae sp. MBIC11093 AB183664, Thraustochytriidae sp. NIOS1 AY705769, Thraustochytriidae sp. #32 DQ323161, Thraustochytriidae sp. #32 DQ356663, Thraustochytriidae sp. RT49 DQ323167, Thraustochytriidae sp. RT49 DQ356669, Thraustochytriidae sp. RT49, Thraustochytriidae sp. Thel2 DQ323162, Thraustochytriidae sp. Thel2;
a Thraustochytrid of a genus Thraustochytrium; more preferably of a species Thraustochytrium sp., Thraustochytrium aggregatum, Thraustochytrium aureum, Thraustochytrium caudivorum, Thraustochytrium gaertnerium, Thraustochytrium kinnei, Thraustochytrium motivum, Thraustochytrium multirudimentale, Thraustochytrium pachydermum, Thraustochytrium roseum, Thraustochytrium striatum, Thraustochytrium visurgense, even more preferably of a strain Thraustochytrium sp. 13A4.1, Thraustochytrium sp. ATCC 26185, Thraustochytrium sp. BL13, Thraustochytrium sp. BL14, Thraustochytrium sp. BL2, Thraustochytrium sp. BL3, Thraustochytrium sp. BL4, Thraustochytrium sp. BL5, Thraustochytrium sp. BL6, Thraustochytrium sp. BL7, Thraustochytrium sp. BL8, Thraustochytrium sp. BL9, Thraustochytrium sp. BP3.2.2, Thraustochytrium sp. BP3.3.3, Thraustochytrium sp. CHN-1, Thraustochytrium sp. FJN-10, Thraustochytrium sp. HK1, Thraustochytrium sp. HK10, Thraustochytrium sp. HK5, Thraustochytrium sp. HK8, Thraustochytrium sp. HK8a, Thraustochytrium sp. KK17-3, Thraustochytrium sp. KL1, Thraustochytrium sp. KL2, Thraustochytrium sp. KL2a, Thraustochytrium sp. ON C-T18, Thraustochytrium sp. PJA10.2, Thraustochytrium sp. TR1.4, Thraustochytrium sp. TRR2, Thraustochytrium aggregatum DQ356662, Thraustochytrium aureum DQ356666, Thraustochytrium kinnei DQ323165, Thraustochytrium striatum ATCC24473, Thraustochytrium striatum DQ323163, Thraustochytrium striatum DQ356665; and
a Thraustochytrid of a genus Ulkenia, more preferably of a species Ulkenia sp., Ulkenia amoeboidea, Ulkenia profunda, Ulkenia visurgensis; even more preferably of a strain Ulkenia sp. ATCC 28207, Ulkenia amoeboidea SEK 214, Ulkenia profunda BUTRBG 111, Ulkenia visurgensis BURAAA 141, Ulkenia visurgensis ATCC 28208.

Still preferably, the Thraustochytrid used according to the present invention is of a genus selected from the group consisting of the genera Aurantiochytrium and Schizochytrium; more preferably of a species selected from the group consisting of the species Aurantiochytrium mangrovei and Schizochytrium sp.; even more preferably of a strain selected from the group consisting of the strains Aurantiochytrium mangrovei CCAP 4062/2 deposited 20 May 2014 at CCAP (CULTURE COLLECTION OF ALGAE AND PROTOZOA, SAMS Research Services Ltd., Scottish Marine Institute, OBAN, Argyl PA37 1QA United Kingdom), Aurantiochytrium mangrovei CCAP 4062/3 deposited 20 May 2014 at CCAP, Aurantiochytrium mangrovei CCAP 4062/4 deposited 20 May 2014 at CCAP, Aurantiochytrium mangrovei CCAP 4062/5 deposited 20 May 2014 at CCAP, Aurantiochytrium mangrovei CCAP 4062/6 deposited 20 May 2014 at CCAP, Aurantiochytrium CCAP 4062/1 deposited 21 Jun. 2013 at CCAP, Schizochytrium sp. CCAP 4087/3 deposited 20 May 2014 at CCAP, Schizochytrium sp. CCAP 4087/1 deposited 28 Feb. 2012 at CCAP, Schizochytrium sp. CCAP 4087/4 deposited 20 May 2014 at CCAP and Schizochytrium sp. CCAP 4087/5 deposited 20 May 2014 at CCAP.

In a preferred embodiment, the Thraustochytrid used according to the present invention is Aurantiochytrium mangrovei FCC1325 (accession number CCAP 4062/5).

The Thraustochytrid biomass used according to the present invention may be used in different forms. It can for instance be in the form of fresh biomass (which can be separated from the culture medium by centrifugation, filtration, decantation and/or any other technique well-known to the skilled person), or it may have undergone some modifications; for instance it may have been submitted to lysis, transformation by fermentation and/or drying. In particular, drying can be performed by any technique well-known to the skilled person, such as spray-drying, lyophilization, fluidized bed, high vacuum evaporation or fluid bed granulation.

The Thraustochytrid biomass used according to the present invention may be used directly as a dietary supplement, or added to or incorporated into a compound feed/balanced diet, a food product or a food composition. In these latter cases, the Thraustochytrid biomass used according to the present invention may be mixed with any other additive, carrier or support, used in the field of food or feed, for human or animal consumption, such as for example food preservatives, dyes, flavor enhancers or pH regulators.

Preferably, the Thraustochytrid biomass used according to the present invention is a feed ingredient (i.e. intended to be incorporated into a compound feed, at an inclusion level ranging from 1% to 60% (w/w), preferably ranging from 1% to 20% (w/w), more preferably ranging from 3% to 8% (w/w)), a feed additive (i.e. intended to be incorporated into a compound feed, at an inclusion level inferior to 1% (w/w)), or is comprised in a compound feed, a food product or a food composition.

The Thraustochytrid biomass used according to the present invention may be intended for animal or human nutrition. Preferably, it is intended for animal nutrition, still preferably for livestock animals or leisure animals feeding. More preferably, it is intended for livestock animals feeding (especially in particularly intensive livestock operations).

These feeds typically appear in the form of flours, crumbles, pellets or slop, into which the Thraustochytrid biomass used according to the present invention can be incorporated. For intensive animal breeding operations, the feeds may comprise, in addition to the Thraustochytrid biomass, a nutritional base and nutritional additives. The essential part of the animal's feed ration thus generally consists of the “nutritional base” and the Thraustochytrid biomass. This base may consist, by way of example, of a mixture of cereals, proteins and fats of animal and/or plant origin. Nutritional bases for animals are adapted to the feeding of these animals and are well-known to the skilled person. In the context of the present invention, these nutritional bases may comprise, for example, corn, wheat, pea and soybean. These nutritional bases are adapted to the needs of the various animal species for which they are intended. These nutritional bases may already contain nutritional additives such as vitamins, mineral salts and amino acids. The additives used in animal feed may be added to improve certain characteristics of the feeds, for example to enhance the flavor thereof, to make the raw materials of the feeds more digestible for the animals or to protect the animals. They are frequently used in large-scale intensive breeding operations. The additives used in animal feeds can be divided into: technological additives (e.g. preservatives, antioxidants, emulsifiers, stabilizers, acidity regulators and silage additives), sensory additives (e.g. flavors, dyes), nutritional additives (e.g. vitamins, amino acids and trace elements), zootechnical additives (e.g. digestibility enhancers, intestinal flora stabilizers), coccidiostats and histomonostats (pesticides).

Even more preferably, the Thraustochytrid biomass used according to the present invention is intended for livestock animals feeding, wherein livestock animals are selected from the group consisting of cattle, sheep, pigs, rabbits, poultry and horses.

All the above-mentioned preferential features of the invention can be considered separately or in any combination.

Another object of the present invention concerns a process for maintaining gut barrier function in an individual, comprising a step of administering to said individual a Thraustochytrid biomass as described previously, and having preferably any of the above-mentioned preferential features, considered separately or in any combination.

### BRIEF DESCRIPTION OF THE DRAWINGS

FIG. 1: Effect of a biomass of Aurantiochytrium mangrovei, in three different forms (fresh, lyophilized or digested lyophilized), on the TER of Caco-2 cells, after 48 h incubation.

FIG. 2: Effect of a biomass of Aurantiochytrium mangrovei, in three different forms (fresh, lyophilized or digested lyophilized), on the TER of Caco-2 cells, after 72 h incubation.

FIG. 3:

Top: Length of colon (in cm/kg of body weight (BW)) of 16-day old chickens. ** P<0.05. Bottom: Visual aspect of colon mucosa. A: Control group receiving the basal diet without DSS administration. B: Control group receiving the basal diet with DSS administration. C: Experimental group receiving the diet containing 5% of Aurantiochytrium mangrovei with DSS administration.

FIG. 4: Concentration of FITC-dextran (in ng/mL) in the plasma of 16-day old chickens, as measured 1 h after oral gavage with FITC-dextran. ** P<0.05.

### EXAMPLES

The present invention is illustrated non-exhaustively by the following examples. These examples are intended for the purpose of illustration only and are not intended to limit the scope of the present invention.

### Example 1: Effect of Thraustochytrid Biomass on the TER of Caco-2 Epithelial Cells

Material and Methods:

Caco-2 cells were used as a model of intestinal epithelial cells. Cells were routinely grown in culture media (DMEM) supplemented with 10% fetal calf serum and 1% antibiotics (streptomycin penicillin solution). Cells were grown in 75 cm² ventilated flasks maintained at 37° C. in a 5% CO₂ incubator. Cells were routinely passaged using trypsin-EDTA solution. For the assay, cells were seeded onto 12-well inserts (Thincert, Greiner, pore size 0.4 μm) at an initial density of 200,000 cells/cm² and let to differentiate for 10-14 days post-seeding before being used, with medium changes every two days. Cell differentiation was confirmed by reading the TER, using a Volt/Ohm meter (Millipore), at the beginning of the experiment, when the TER value reached 600 Ohm/cm².

Deoxynivalenol (DON) was used to induce an increased permeability, and various forms of microalgae (Aurantiochytrium mangrovei FCC1325) preparations were tested for their ability to reduce the effect of DON:
fresh microalgae “MF” (i.e. culture from the fermenter without further processing);
lyophilized microalgae “ML” (i.e. microalgae biomass after centrifugation of the culture broth from the fermenter, and lyophilization of the pelleted cells), and
digested lyophilized microalgae “MLD” (i.e. lyophilized microalgae which have been digested in a two-step enzymatic in vitro assay mimicking the pig intestinal tract). The digestion method had two stages: In the first stage, 150 mg of the lyophilized microalgae on a dry matter (DM) basis was weighed into 12 mL tubes containing 7 mL of HCl 0.04 M adjusted to pH 2. A volume of 0.1 mL of pepsin (pig pepsin at 700 FIP-U/g, Merck) dissolved in demineralized water was added to each tube in order to reach a final activity of 500 U/g of tested microalgae on a DM basis. The tubes were incubated with shaking at 15 rotations/min for 2 h at 37° C. At the end of the first incubation period, a second stage mimicking the pancreatic digestion was applied by adding 3 mL of phosphate buffer at pH 7.2 and a pancreatic solution to the digestion tubes. The enzyme solution was prepared (pig pancreatin, grade IV-Sigma n° P-1750, Sigma-Aldrich) at 100 mg/mL in demineralized water, and 0.1 mL of that solution was added to each tube. The digestion mixture was then incubated for an additional 4 h at 37° C. with shaking at 15 rotations/min. After incubation, the microalgae residue remaining after digestion was collected on 50 μm filters, then rinsed first with ethanol for 5-10 min and then acetone for 5-10 min. The digested lyophilized microalgae biomass was finally oven-dried at 35-40° C. (+/−2° C.) for 72 h.

Both lyophilized (ML) and digested lyophilized (MLD) microalgae powders were resuspended initially at 0.8 mg/ml in buffer (fresh culture medium of the microalgae).

After differentiation, Caco-2 cells were put in contact, during 48 or 72 h, with or without DON at different concentrations (0, 6.25, 12.5, 25, 50 or 100 μM), and with activated charcoal at 1% (w/v) as positive control, or with or without one of the microalgae preparation type at different concentrations (1, 5, or 20% v:v, final dilution), each added on the apical side. At the end of the incubation time, the TER was measured using a Volt/Ohm meter (Millipore), and results were expressed in percentages of the control put in contact with the same concentration of DON but not with the tested product (microalgae or charcoal). Each condition was tested in triplicates (n=3).

Results:

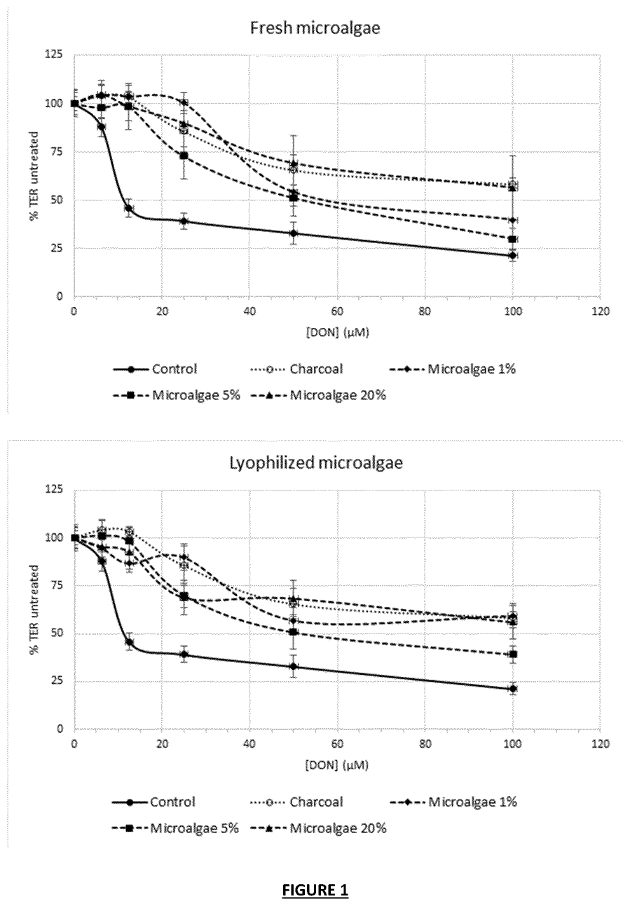

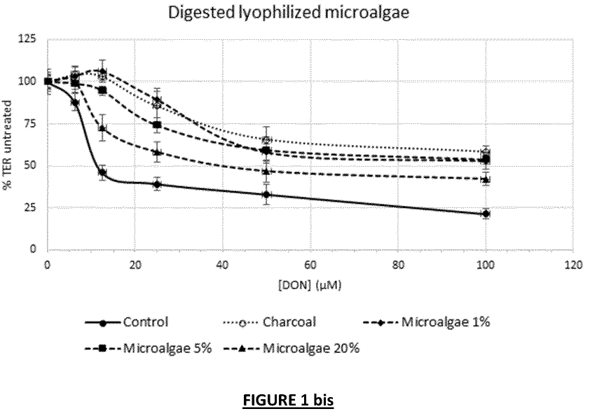

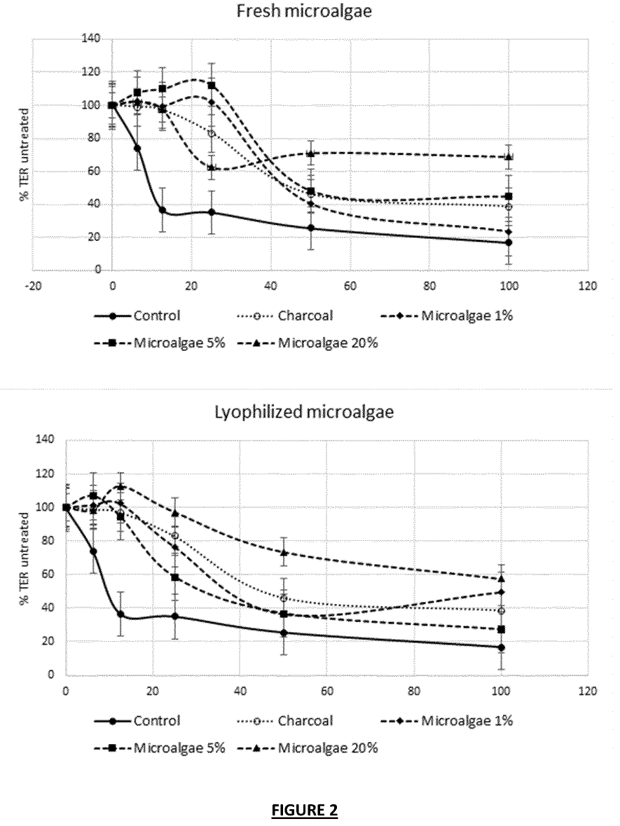

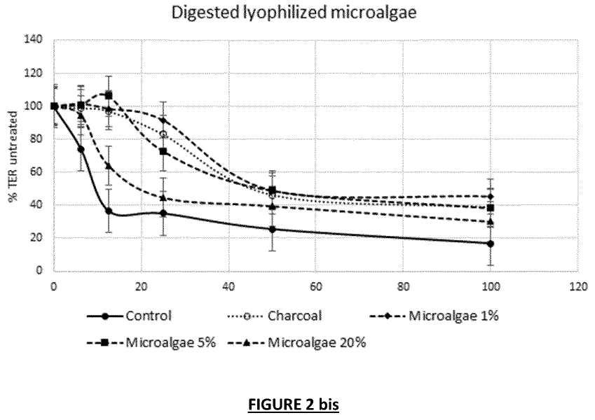

The addition of DON only to the cell medium induced a reduction of the TER (corresponding to an increased permeability), which was even more pronounced as the concentration of DON increased (see “control” condition in FIGS. 1 and 2). Charcoal was able to partially prevent the TER reduction induced by DON, at all incubation times and DON concentrations. Similarly, the microalgae in all the three tested forms (whether fresh culture or processed biomass) also partially prevented the TER reduction induced by DON, at all incubation times and DON concentrations (see FIGS. 1 and 2).

The half-maximal inhibitory concentration (IC50) is a measure of the potency of a substance in inhibiting a specific biological or biochemical function. This quantitative measure, typically expressed as molar concentration, indicates how much of a particular substance (inhibitor) is needed to inhibit a given biological process by half. The analysis of IC50 at 48 h incubation (Table 1) clearly confirmed the ability of the microalgae to prevent the DON effect on the Caco-2 TER. At 1 and 5%, the fresh and lyophilized microalgae biomass appeared to be the most protective (IC50 values 3-10 times higher, compared to control), while at a concentration of 20%, the digested lyophilized microalgae showed better protection than the fresh and lyophilized biomasses.

TABLE 1
IC50 at 48 h incubation

| | IC50 (μM) | |
|---|---|---|
| Condition | at 48 h | |
| Control | 11 | μM |
| Charcoal | >100 | μM |
| Fresh microalgae 1% | 57 | μM |
| Fresh microalgae 5% | 51 | μM |
| Fresh microalgae 20% | >100 | μM |
| Lyophilized microalgae ML 1% | >100 | μM |
| Lyophilized microalgae ML 5% | 52 | μM |
| Lyophilized microalgae ML 20% | >100 | μM |
| Digested lyophilized microalgae MLD 1% | 100 | μM |
| Digested lyophilized microalgae MLD 5% | 100 | μM |
| Digested lyophilized microalgae MLD 20% | 39 | μM |

After a 72-h incubation, some of the microalgae showed higher preventive effect than charcoal, and the most efficient prevention was obtained with microalgae at 20% (FIG. 2).

### Example 2: Effect of Thraustochytrid Biomass on Nutrient Uptake by Caco-2 Epithelial Cells

Material and Methods:

In order to test the ability of microalgae to reduce/prevent the effect of DON on nutrient absorption through epithelial cells, Caco-2 cells were exposed to a metabolically active dose of DON, in the absence or presence of Aurantiochytrium mangrovei FCC1325 microalgae (lyophilized microalgae “ML”, or digested lyophilized microalgae “MLD”), at a dose of 1% or 5%. Two main types of nutrients were considered (i.e. glucose and amino acids—more particularly Methionine, Lysine and Threonine), and the following measurements were carried out:
For glucose (D-Glc): passive, active (regulated by the sodium-dependent SGLT-1 transporter) and total (active+passive) absorption
For amino acids (L-Methionine, L-Lysine and L-Threonine): passive, active (regulated by sodium-dependent transport) and total (active+passive) absorption

Briefly, Caco-2 cells were cultured and seeded onto 12-well inserts, as described in Example 1, and then let to differentiate for 16-21 days post-seeding before being used, with medium changes every two days. When differentiated, Caco-2 cells were incubated or not with DON at 10 μM (apically added), in the absence or presence of 1 or 5% (v:v final dilution, apically added) of microalgae preparation (ML or MLD). Both ML and MLD powders were resuspended initially at 0.8 mg/ml in buffer (fresh culture medium of the microalgae). Caco-2 cells were incubated for 12, 24 or 48 hours before nutrient uptake was measured.

At the end of the incubation period, inserts were washed twice with PBS++. Inserts were then washed twice with uptake buffer (Ringer Hepes buffer) with or without sodium. Uptake buffer composition was:
Ringer Hepes buffer with sodium (called “+Na+”): 137 mmol/L NaCl, 5.36 mmol/L KCl, 0.4 mmol/L Na₂HPO₄, 0.8 mmol/L MgCl₂, 1.8 mmol/L CaCl₂, 20 mmol/L N-2-hydroxyethylpiperazine-N-2-ethanesulfonic acid (HEPES), pH being adjusted to pH 7.4 with NaOH; or
Ringer Hepes buffer without sodium (called “—Na+”): 137 mmol/L Choline chloride (instead of sodium chloride), 5.36 mmol/L KCl, 0.4 mmol/L K₂HPO₄ (instead of Na₂HPO₄), 0.8 mmol/L MgCl₂, 1.8 mmol/L CaCl₂, 20 mmol/L N-2-hydroxyethylpiperazine-N-2-ethanesulfonic acid (HEPES), pH being adjusted to pH 7.4 with KOH.

After an equilibration period of 15 min at 37° C., uptake assay was initiated by the addition of D-Glc, L-Lysine, L-Methionine or L-Threonine diluted in the appropriate Ringer Hepes buffer (400 μl) and added apically onto Caco-2 inserts (final concentration of 100 μM of D-Glc and 400 μM for amino-acids), the basolateral compartment being filled with 400 μl of buffer. Inserts were kept incubated at 37° C. during the uptake assay. After 15 minutes incubation, 30 μl of media were collected from apical or basolateral compartments and stored at −20° C. until nutrient quantification. Residual concentrations of D-Glc or L-amino acid present in the apical compartments were measured using enzyme-based quantification assay kits (Glucose Colorimetric/Fluorometric Assay Kit, Sigma-Aldrich).

Uptakes were expressed as:
Total uptake: uptake measured (either measured residual apical concentration or calculated absorbed (intracellular+basolateral) concentration) in Ringer Hepes buffer with Na+corresponding to the activity of sodium-dependent and sodium-independent transporters;
Passive uptake: uptake measured in Ringer Hepes buffer without Na+corresponding to only passive/sodium-independent transporters;
Active uptake: uptake calculated by subtracting passive uptake to total uptake.

Results:

D-Glc Uptake after Exposure to DON, in the Absence or Presence of Microalgae

12 h Incubation

At 12 h incubation (see Table 2), ML and MLD suppressed DON effect on total Glc uptake (ML 5% and MLD 1/5%), passive uptake (ML 5% and MLD 1/5%) and SGLT-1 activity (all ML and MLD).

TABLE 2
Percentage of inhibition of D-glucose uptake by DON after
12 h treatment of Caco-2 cells with different microalgae
preparations in comparison with cells not treated with DON

% of inhibition by DON

| | Total uptake | Passive uptake | SGLT-1 |
|---|---|---|---|
| | (+Na) | (−Na) | mediated |
| Control + DON | 9.3 | 6.4 | 19.2 |
| ML 1% + DON | 28.3 | 37.8 | −29.4 |
| ML 5% + DON | −24.1 | −23.0 | −29.5 |
| MLD 1% + DON | −5.7 | 4.4 | −60.1 |
| MLD 5% + DON | −8.1 | −9.3 | −2.7 |

24 Incubation

At 24 h incubation, ML and MLD reversed/prevented DON-mediated inhibition of total, passive and active D-Glc uptake (see Table 3).

TABLE 3
Percentage of inhibition of D-glucose uptake by DON after
24 h treatment of Caco-2 cells with different microalgae
preparations in comparison with cells not treated with DON

% of inhibition by DON

| | Total uptake | Passive uptake | SGLT-1 |
|---|---|---|---|
| | (+Na) | (−Na) | mediated |
| Control + DON | 29.4 | 22.2 | 52.3 |
| ML 1% + DON | 5.3 | 13.9 | −36.8 |
| ML 5% + DON | −18.9 | −10.0 | −211.0 |
| MLD 1% + DON | 4.7 | −8.8 | 44.5 |
| MLD 5% + DON | −5.8 | 1.0 | −46.8 |

48 h Incubation

At 48 h incubation, similarly as for the 24 h incubation, ML and MLD reversed/prevented DON-mediated inhibition of total, passive and active D-Glc uptake.

TABLE 4
Percentage of inhibition of D-glucose uptake by DON after
48 h treatment of Caco-2 cells with different microalgae
preparations in comparison with cells not treated with DON

% of inhibition by DON

| | Total uptake | Passive uptake | SGLT-1 |
|---|---|---|---|
| | (+Na) | (−Na) | mediated |
| Control + DON | 28.8 | 21.6 | 51.4 |
| ML 1% + DON | 20.3 | 19.4 | 24.9 |
| ML 5% + DON | −22.6 | −19.6 | −128.2 |
| MLD 1% + DON | −9.6 | −14.2 | 7.4 |
| MLD 5% + DON | −9.8 | −4.2 | −38.4 |

L-Amino Acids Uptake after Exposure to DON, in the Absence or Presence of Microalgae

12 h Incubation

ML and MLD did not prevent the effect of DON on total or passive L-Lys absorption but ML 1% and MLD 1% were able to prevent L-Lys active uptake inhibition by DON (Table 5).

TABLE 5
Percentage of inhibition of L-Lysine uptake by DON after
12 h treatment of Caco-2 cells with different microalgae
preparations in comparison with cells not treated with DON

| | % of inhibition by DON | | |
|---|---|---|---|
| | Total uptake | Passive uptake | Active |
| | (+Na) | (−Na) | transport |
| Control | −5.2 | −6.1 | 57.5 |
| ML 1% | −12.6 | −14.5 | 18.1 |
| ML 5% | −7.4 | −15.3 | 68.1 |
| MLD 1% | −23.6 | −28.1 | 28.1 |
| MLD 5% | −29.5 | −44.0 | 63.7 |

Contrarily to L-Lys and L-Thr that were inhibited by DON, L-Met active uptake was stimulated by DON. ML and MLD were able to limit L-Met uptake stimulation by DON (Table 6).

TABLE 6
Percentage of inhibition of L-Methionine uptake by DON after
12 h treatment of Caco-2 cells with different microalgae preparations
in comparison with cells not treated with DON

% of inhibition by DON

| | Total uptake | Passive uptake | Active |
|---|---|---|---|
| | (+Na) | (−Na) | transport |
| Control + DON | −9.6 | −2.2 | −256.0 |
| ML 1% + DON | −5.6 | 2.2 | −129.1 |
| ML 5% + DON | −9.6 | −8.5 | −28.1 |
| MLD 1% + DON | −7.2 | −0.4 | −159.4 |
| MLD 5% + DON | −8.8 | −15.6 | 66.9 |

ML but not MLD were able to limit L-Thr active uptake inhibition by DON (Table 7).

TABLE 7
Percentage of inhibition of L-Threonine uptake by DON after
12 h treatment of Caco-2 cells with different microalgae
preparations in comparison with cells not treated with DON

% of inhibition by DON

| | Total uptake | Passive uptake | Active |
|---|---|---|---|
| | (+Na) | (−Na) | transport |
| Control + DON | −6.3 | −9.5 | 56.5 |
| ML 1% + DON | −18.1 | −14.6 | −82.6 |
| ML 5% + DON | −14.1 | −7.6 | −255.4 |
| LD 1% + DON | −43.0 | −97.5 | 61.5 |
| MLD 5% + DON | −74.6 | −94.4 | 14.3 |

24 h Incubation

Table 8 shows that ML 1% (but not the other forms of microalgae) was able to reverse the effect of DON on active L-Lys uptake.

Table 9 shows that both ML and MLD prevented DON effects on L-Met active transport.

Table 10 shows that ML and MLD 5% prevented the inhibition of L-Thr active uptake by DON.

TABLE 8
Percentage of inhibition of L-Lysine uptake by DON after
24 h treatment of Caco-2 cells with different microalgae
preparations in comparison with cells not treated with DON

% of inhibition by DON

| | Total uptake | Passive uptake | Active |
|---|---|---|---|
| | (+Na) | (−Na) | transport |
| Control + DON | −5.2 | −10.1 | 44.2 |
| ML 1% + DON | −10.5 | −8.1 | −38.9 |
| ML 5% + DON | −8.2 | −18.3 | 72.9 |
| MLD 1% + DON | −19.5 | −27.6 | 53.5 |
| MLD 5% + DON | −36.3 | −49.1 | 33.1 |

TABLE 9
Percentage of inhibition of L-Methionine uptake by DON after
24 h treatment of Caco-2 cells with different microalgae preparations
in comparison with cells not treated with DON

% of inhibition by DON

| | Total uptake | Passive uptake | Active |
|---|---|---|---|
| | (+Na) | (−Na) | transport |
| Control + DON | −12.9 | −4.9 | −5220.8 |
| ML 1% + DON | −9.5 | −13.5 | 28.7 |
| ML 5% + DON | −3.5 | −1.1 | −46.8 |
| MLD 1% + DON | −4.2 | 8.0 | −467.3 |
| MLD 5% + DON | −17.3 | −1.3 | −676.6 |

TABLE 10
Percentage of inhibition of L-Threonine uptake by DON after
24 h treatment of Caco-2 cells with different microalgae
preparations in comparison with cells not treated with DON

% of inhibition by DON

| | Total uptake | Passive uptake | Active |
|---|---|---|---|
| | (+Na) | (−Na) | transport |
| Control + DON | −6.3 | −9.5 | 56.5 |
| ML 1% + DON | −18.1 | −14.6 | 82.6 |
| ML 5% + DON | −14.1 | −7.6 | −255.4 |
| MLD 1% + DON | −43.0 | −97.5 | 61.5 |
| MLD 5% + DON | −74.6 | −94.4 | 14.3 |

48 h Incubation

At 48 h incubation, DON stimulated active L-Lys uptake. This effect was prevented by ML but not by MLD (Table 11). At 48 h incubation, DON stimulated active L-Met uptake. This effect was prevented by ML and MLD 5% but not by MLD 1% (Table 12).

TABLE 11
Percentage of inhibition of L-Lysine uptake by DON after
48 h treatment of Caco-2 cells with different microalgae
preparations in comparison with cells not treated with DON

% of inhibition by DON

| | Total uptake | Passive uptake | Active |
|---|---|---|---|
| | (+Na) | (−Na) | transport |
| Control + DON | −9.4 | −6.6 | −102.3 |
| ML 1% + DON | −11.1 | −15.0 | 54.6 |
| ML 5% + DON | −6.2 | −22.4 | 87.0 |
| MLD 1% + DON | −29.2 | −25.3 | −202.9 |
| MLD 5% + DON | −41.9 | −38.6 | −201.1 |

TABLE 12
Percentage of inhibition of L-Methionine uptake by DON after
48 h treatment of Caco-2 cells with different microalgae preparations
in comparison with cells not treated with DON

% of inhibition by DON

| | Total uptake | Passive uptake | Active |
|---|---|---|---|
| | (+Na) | (−Na) | transport |
| Control + DON | −4.1 | 1.8 | −102.4 |
| ML 1% + DON | −1.4 | 0.4 | −36.1 |
| ML 5% + DON | −6.2 | −8.1 | 39.5 |
| MLD 1% + DON | −25.2 | 3.0 | −739.2 |
| MLD 5% + DON | −9.0 | −8.0 | −24.0 |

Table 13 shows that both ML and MLD prevented partially the inhibition of active L-Thr uptake by DON.

TABLE 13
Percentage of inhibition of L-Threonine uptake by DON after
48 h treatment of Caco-2 cells with different microalgae
preparations in comparison with cells not treated with DON

% of inhibition by DON

| | Total uptake | Passive uptake | Active |
|---|---|---|---|
| | (+Na) | (−Na) | transport |
| Control + DON | −14.5 | −16.9 | 76.4 |
| ML 1% + DON | −6.0 | −11.1 | 39.6 |
| ML 5% + DON | −16.0 | −27.0 | 43.4 |
| MLD 1% + DON | −46.9 | −76.8 | 42.8 |
| MLD 5% + DON | −60.6 | −83.3 | 45.1 |

### CONCLUSION

The most important uptakes to be considered are total uptake (in order to have a global view of nutrient uptake capacity) and active uptake (in order to evaluate anti-diarrheal nutrient uptake activity). Overall, results are consistent with previously published results obtained with radioactive nutrients and HT-29-D4 cells, confirming that DON at 10 μM alters intestinal nutrient uptake. These first observations suggested that the lyophilized microalgae with or without pre-digestion is able to partially reverse/prevent DON-mediated impact on total, passive, and active uptake of glucose, Lysine, Threonine, and Methionine.

### Example 3: Effect of Thraustochytrid Biomass on Colon Histo-Morphology and Gut Permeability in Broiler Chickens

Material and Methods:
Experimental animals: Day-of-hatch male Ross 308 broilers were obtained from a local hatchery, placed in floor pens until 6 days of age, and provided heat to maintain an age-appropriate temperature. Chicks were provided ad libitum access to water and the balanced experimental diets meeting the poultry nutrition requirements recommended for Ross 308 broilers during the starter period from 1 to 16 days of age.
Experimental diets: A basal starter diet (CON) in the form of short pellets was formulated based on wheat, corn, and soybean meal (Table 14). The other experimental diets were formulated to contain 5% microalgae Aurantiochytrium mangrovei (MAG-5) or 2% curcumin (CUM-2) by replacing part of the cereal, protein or oil content. The 3 diets were formulated to be isoenergetic and isoprotein (Table 15).

TABLE 14
Ingredient composition of the experimental diets.

| INGREDIENTS (G/KG) | CON | MAG-5 | CUM-2 |
|---|---|---|---|
| CORN | 40.00 | 40.00 | 40.00 |
| WHEAT | 21.22 | 21.67 | 19.19 |
| SOYBEAN MEAL 48 | 30.10 | 24.57 | 30.41 |
| SOY OIL | 1.84 | 1.88 | 1.62 |
| SOYBEANS | 3.00 | 3.00 | 3.00 |
| MICROALGAE | — | 5.00 | — |
| CURCUMIN | — | — | 2.00 |
| DICALCIUM PHOSPHATE | 1.77 | 1.69 | 1.78 |
| CALCIUM CARBONATE | 0.50 | 0.58 | 0.41 |
| SALT | 0.28 | 0.28 | 0.28 |
| L-LYSINE HCL 78% | 0.23 | 0.24 | 0.23 |
| DL-METHIONINE 99 | 0.32 | 0.32 | 0.33 |
| L-THREONINE 98% | 0.05 | 0.07 | 0.05 |
| SODIUM BICARBONATE | 0.10 | 0.10 | 0.10 |
| MINERAL PREMIX + ELANCOBAN | 0.60 | 0.60 | 0.60 |
| TOTAL | 100.00 | 100.00 | 100.00 |

TABLE 15
Nutritional composition of the experimental diets.

| NUTRIENTS (%) | CON | MAG-5 | CUM-2 |
|---|---|---|---|
| AME (KCAL/KG) | 2950 | 2950 | 2950 |
| CRUDE PROTEIN | 20.7 | 20.5 | 20.7 |
| CRUDE FAT | 4.56 | 4.93 | 4.49 |
| CRUDE FIBRE | 3.25 | 3.18 | 3.47 |
| DIGESTIBLE LYSINE | 1.08 | 1.08 | 1.08 |
| DIGESTIBLE MET + CYS | 0.90 | 0.90 | 0.90 |
| DIGESTIBLE THREONINE | 0.68 | 0.68 | 0.68 |
| DIGESTIBLE TRYPTOPHANE | 0.23 | 0.22 | 0.23 |
| DIGESTIBLE ARGININE | 1.22 | 1.23 | 1.22 |
| DIGESTIBLE VALINE | 0.82 | 0.81 | 0.82 |
| DIGESTIBLE ISOLEUCINE | 0.78 | 0.75 | 0.78 |
| DIGESTIBLE LEUCINE | 1.50 | 1.45 | 1.50 |
| TOTAL CALCIUM | 0.89 | 0.89 | 0.89 |
| TOTAL PHOSPHORUS | 0.69 | 0.77 | 0.69 |
| AVAILABLE PHOSPHORE | 0.40 | 0.40 | 0.40 |
| SODIUM | 1.5 | 1.5 | 1.5 |

Dextran Sulfate Sodium (DSS) administration: DSS was used to increase intestinal permeability in broilers, by inducing epithelium damage. DSS (MW 40 kDa, Alfa Aesar, Ward Hill, Mass.) was administered from day 10 to 15 at a concentration of 0.75% (wt/vol) in drinking water. At the end of day 15, all groups were provided fresh water without DSS until final collection of samples at day 16. The DSS solution was prepared daily in fresh water and distributed through individual bottles of water directly connected to the drinking system of each cage. Each bottle was weighted before and after filling with the new DSS solution in order to measure the daily consumption of DSS par cage. Control animals received normal drinking water ad libitum from day 1 to day 16.
Experimental design and measurements of colon length and gut permeability: At 6 days of age, a total of 144 broiler chicks were randomly divided into 4 groups of 12 cages (3 chicks/cage): 1 control group given the control starter diet, and 3 groups receiving DSS and fed on each of the 3 experimental diets (control starter diet, microalgae diet, and curcumin diet—see Table 14). At day 16 (5 d of DSS), chickens were dosed with 2 mL of FITC-dextran (MW 4000; Sigma Aldrich Co., St. Louis, Mo.) by oral gavage at 8 mg/kg in water to detect enteric leakage. One hour after oral gavage, 24 birds from each condition (2 birds/cage) were humanely killed by CO₂ inhalation and bled for plasma collection. Blood was kept on ice in EDTA tubes after sampling, and centrifuged (2000×g for 15 min) to separate plasma. Fluorescence levels of diluted plasma (1:4 in saline solution 0.9% NaCl) were measured at an excitation wavelength of 485 nm and emission wavelength of 528 nm (BIOTEK synergie H1), and FITC-dextran concentration per mL of plasma was calculated based on a standard curve.
At the time of euthanisa, the colon was collected for morphometry. Briefly, the digestive tract of each bird from the proximal esophagus to the cloaca was carefully removed from the body cavity. The colon (from the ileocecal junction to the cloaca) was then excised and its length was measured.

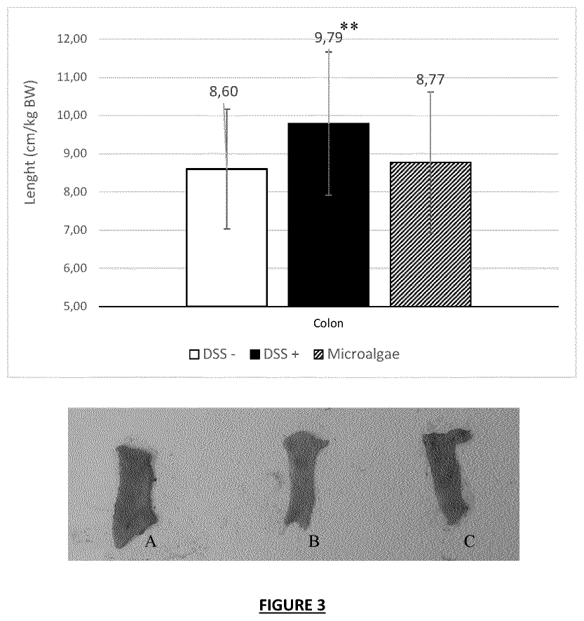

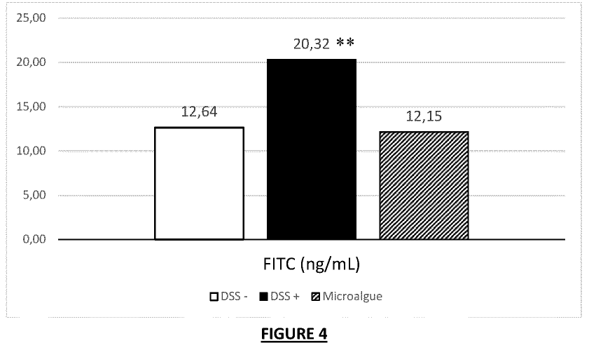

Results:
Digestive tract measurement (colon length): the length of the colon was measured directly after euthanasia at 16 days of age, and reported of individual body weight. These results, as well as visual observation of the colon mucosa, are presented in FIG. 3. The addition of DSS at 2% in the drinking water significantly increased the length of the colon of the control birds receiving the DSS (“DSS+”), compared to the group that did not receive DSS (“DSS-”), maybe due to an effect of partial compensation for the loss of absorptive and secretive functionalities of the gut due to DSS administration. Adding Aurantiochytrium mangrovei in the control diet at 5% induced a reduction of the colon length to a level not significantly different from the animals fed on the control diet and not receiving DSS (compare “microalgae” and “DSS-” in FIG. 3, top). This observation may be correlated to the visual observation of the colon mucosa (FIG. 3, bottom). The addition of DSS in the drinking water affected the mucosa of the colon which became thinner, translucent, and more fragile in comparison with the DSS-control group (B vs A, FIG. 3, bottom). The birds which received the DSS and the control diet supplemented with Aurantiochytrium mangrovei did not show any visual modification of the colon mucosa compared to the control birds without DSS (C vs A, FIG. 3, bottom).
Gut permeability: The influence of DSS on the integrity of the intestinal barrier was assessed by measuring the flow of a fluorescent-labelled marker (FITC-dextran) through the epithelium, 1 h after euthanasia via blood analysis (FIG. 4). Administration of DSS significantly increased the flow of FITC-dextran through the gut barrier, as illustrated by the rise in FITC-dextran concentration in the blood 1 h after oral gavage. Therefore, gut epithelium integrity was impaired by the administration of DSS. Adding the microalgae at 5% in the experimental diet induced a reduction of the FITC-dextran concentration in the broiler plasma to a concentration very close to the FITC-dextran level measured in the plasma of non-DSS treated birds (12.15 vs 12.65 ng/mL) (FIG. 4). The results suggest that the barrier integrity in the case of chickens given the microalgae-based diet was maintained, and that the loss in epithelium impermeability induced by the DSS treatment was prevented with the microalgae.

1. A method for maintaining gut barrier function in an individual, comprising administering a Thraustochytrid biomass for maintaining gut barrier function in an individual to an animal in need thereof.

2. The method according to claim 1, wherein the individual is an individual submitted to stressful or challenging conditions.

3. The method according to claim 1, wherein said Thraustochytrid is of a genus selected from the group consisting of the genera Aplanochytrium, Aurantiochytrium, Botryochytrium, Japonochytrium, Oblongichytrium, Parietichytrium, Phytophthora, Schizochytrium, Sicyoidochytrium, Thraustochytriidae, Thraustochytrium and Ulkenia.

4. The method according to claim 3, wherein said Thraustochytrid is of a genus selected from the group consisting of the genera Aurantiochytrium and Schyzochytrium.

5. The method according to claim 4, wherein said Thraustochytrid is of a species selected from the group consisting of the species Aurantiochytrium mangrovei and Schizochytrium sp.

6. The method according to claim 5, wherein said Thraustochytrid is of a strain selected from the group consisting of the strains Aurantiochytrium mangrovei CCAP 4062/2; Aurantiochytrium mangrovei CCAP 4062/3; Aurantiochytrium mangrovei CCAP 4062/4; Aurantiochytrium mangrovei, CCAP 4062/5; Aurantiochytrium mangrovei CCAP 4062/6; Aurantiochytrium mangrovei CCAP 4062/1; Schizochytrium sp. 4087/3; Schizochytrium sp. CCAP 4087/1; Schizochytrium sp. CCAP 4087/4; and Schizochytrium sp. CCAP 4087/5.

7. The method according to claim 6, wherein said Thraustochytrid is of the strain Aurantiochytrium mangrovei CCAP 4062/5.

8. The method according to claim 1, wherein said Thraustochytrid biomass is in the form of fresh biomass.

9. The method according to claim 1, wherein said Thraustochytrid biomass has been submitted to lysis, transformation by fermentation and/or drying.

10. The method according to claim 1, wherein the Thraustochytrid biomass is a feed ingredient or a feed additive.

11. The method according to claim 1, wherein the Thraustochytrid biomass is added to or incorporated into a compound feed, a food product or food composition.

12. The method according to claim 1, wherein the Thraustochytrid biomass is intended for animal nutrition.

13. The method according to claim 12, wherein the Thraustochytrid biomass is intended for livestock animals feeding.

14. The method according to claim 13, wherein livestock animals are selected from the group consisting of cattle, sheep, pigs, rabbits, poultry and horses.
